(19) United States
(12) Patent Application Publication
(10) Pub. No.: US 2019/0069142 A1
(43) Pub. Date: Feb. 28, 2019

(54) REAL TIME TEXT TRANSMISSION BEFORE ESTABLISHING A PRIMARY COMMUNICATION SESSION

(71) Applicant: T-Mobile USA, Inc., Bellevue, WA (US)

(72) Inventors: Hsin-Fu Henry Chiang, Bellevue, WA (US); Yasmin Karimli, Kirkland, WA (US); Boris Antsev, Bothell, WA (US)

(73) Assignee: T-Mobile USA, Inc.

(21) Appl. No.: 15/693,177

(22) Filed: Aug. 31, 2017

(51) Int. Cl. H04W 4/12; H04W 76/02; H04W 4/22

(52) U.S. Cl. CPC H04W 4/12; H04W 4/22; H04W 76/02

(57) ABSTRACT

Text content may be exchanged in a real time text (RTT) message during setup of, and prior to establishing, a primary communication session over a telecommunications network. An originating UE, upon receiving user input requesting to establish a primary communication session, may send, over a telecommunications network, a session request to establish the primary communication session. Prior to establishing the primary communication session, however, and during an early media communication session, the originating UE may send text content in a RTT message, and may establish the primary communication session after sending the text content in the RTT message.

### BACKGROUND

Communication devices have traditionally been used to facilitate oral communication (e.g., talking) over a telecommunications network. However, non-oral communication remains important in today's society. For example, some people simply prefer texting over talking, while others, such as the hearing and speech impaired, may be physically unable to communicate orally.

Teletypewriter (TTY) technology was developed in the 1960's to allow the hearing and speech impaired to communicate using text over standard telephone lines. TTY was later implemented in wireless networks for use with mobile handsets, but as wireless networks evolved from a circuit-switched (CS) architecture to a packet-switched (PS) architecture, TTY technology became unsuitable for use in wireless networks, which are primarily based on Internet Protocol (IP) communications. This led to a decision by the Federal Communications Commission (FCC) to mandate that carriers replace legacy TTY technology with real time text (RTT) technology.

RTT allows for a near instantaneous transmission of text content between IP-based terminals. As a user of a source device types a RTT message, the text content of the RTT message is displayed on a destination device in real-time, without requiring the user of the source device to select a “send” button. This near instantaneous transmission of text content resembles a more natural conversation that is preferred by the hearing and speech impaired over traditional text messaging (e.g., Short Message Service (SMS) text). RTT also allows both parties of a communication session to type concurrently (e.g., allowing one user to interrupt the other user), and RTT can be implemented as an add-on to voice, which enables simultaneous voice and RTT media streams. However, technical limitations of RTT technology only allow a user to create and send RTT messages after a communication session is successfully established. Furthermore, because of RTT's newness, the networking implementations of RTT technology are rather limited today.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 is a diagram illustrating an originating user equipment (UE) configured to send, over a telecommunications network, a RTT message to a terminating UE prior to establishing a primary communication session with the terminating UE, FIG. 1 showing example signaling to enable the early transmission and receipt of the RTT message during setup of the primary communication session.

FIG. 2A is a diagram illustrating an originating UE configured to send, over a telecommunications network, a RTT message to a Public Safety Answering Point (PSAP) prior to establishing a primary communication session with the PSAP, FIG. 2A showing example signaling to enable the early transmission and receipt of the RTT message during setup of the primary communication session.

FIG. 2B is a diagram illustrating an originating UE configured to send, over a telecommunications network, an automatically-generated RTT message as the first RTT message sent to a PSAP during a primary communication session with the PSAP, FIG. 2B showing example signaling to enable the transmission and receipt of the initial, automatically-generated RTT message during the primary communication session

FIG. 3 is a diagram illustrating a UE configured to receive, over a telecommunications network, a RTT message from a PSAP after a failure of an initial communication session, and prior to establishing a subsequent, primary communication session with the PSAP, the subsequent communication session representing a callback from the PSAP, FIG. 3 showing example signaling to enable the early transmission and receipt of the RTT message during setup of the subsequent, primary communication session.

FIG. 4 illustrates an example user interface of an originating UE that is displayed during setup of a communication session, the user interface presenting a RTT selection element for sending a RTT message prior to establishing the communication session.

FIG. 5 illustrates an example user interface of an originating UE that is displayed during setup of a communication session, the user interface presenting a text input mechanism for sending a RTT message prior to establishing the communication session.

FIG. 6 illustrates an example user interface of a terminating UE that is displayed during setup of a communication session, the user interface presenting a RTT message received from a calling party prior to establishing the communication session.

FIG. 7 illustrates a flowchart of an example process for early transmission of a RTT message during setup of a primary communication session.

FIG. 8 illustrates a flowchart of a more detailed example process for early transmission of a RTT message during setup of a primary communication session.

FIG. 9 illustrates a flowchart of an example process for early reception of a RTT message during setup of a primary communication session.

FIG. 10 illustrates a flowchart of an example process of a more detailed example process for early reception of a RTT message during setup of a primary communication session.

FIG. 11 illustrates a flowchart of an example process for early reception of a RTT message in a callback from a PSAP.

FIG. 12 illustrates a flowchart of an example process for automatically sending, without user interaction, text content by an originating UE in a first RTT message of many possible RTT messages that can be sent during the communication session.

FIG. 13 is a block diagram of an example UE configured to transmit and receive RTT messages prior to, and during, a primary communication session.

### DETAILED DESCRIPTION

Described herein are, among other things, techniques and systems for exchanging text content in a real time text (RTT) message during setup of, and prior to establishing, a primary communication session over a telecommunications network. This disclosure describes various scenarios in which terminals can exchange text content in “early” RTT messages. In an example scenario, an originating UE can send an early RTT message to a terminating UE. In another example scenario, an originating UE can send an early RTT message to a PSAP, such as when a calling party dials an emergency short code (e.g., 911 in the United States). On the receiving end, a terminal (e.g., a terminating UE, a PSAP terminal, etc.) may receive an early RTT message during session setup, and the terminal may be configured to reply to the originating device with an early RTT message prior to establishing the primary communication session.

A process to be implemented by an originating UE can include receiving user input requesting to establish a primary communication session, sending, over a telecommunications network, a session request to establish the primary communication session. Prior to establishing the primary communication session, however, the originating UE can send, during an early media communication session, text content in a RTT message. After sending the text content in the RTT message, the originating UE may establish the primary communication session.

A process to be implemented by a terminal that receives an incoming request (e.g., a terminating UE, a PSAP terminal, etc.) can include receiving, over a telecommunications network, a session request to establish a primary communication session, and initiating a session setup for the primary communication session. Prior to completing the session setup for establishing the primary communication session, however, the terminal may receive, during an early media communication session, a RTT message, and may display, on a display of the terminal, text content of the RTT message. Thereafter, the terminal may receive user input indicating that a user of the terminal accepts the request to establish the primary communication session, and the terminal may establish the primary communication session after having displayed the text content of the RTT message, and in response to receiving the user input accepting the request.

By enabling early exchange of text content in RTT messages prior to establishing a primary communication session, one or more devices can be configured to conserve resources with respect to communications bandwidth resources, processing resources, memory resources, power resources, and/or other resources. These technical effects may be downstream effects from the utilization of early transmission of text content in RTT messages. For instance, text content of RTT messages can provide contextual information to a called party. When such contextual information is received prior to establishing a primary communication session (e.g., prior to the called party accepting the incoming request), the called party is likely to be better informed, which may, for instance, reduce and/or eliminate repeated attempts by the calling party to contact the called party, thereby conserving communications bandwidth resources and other resources (both on the terminals and in the telecommunications network) that may be required to handle repeated attempts at establishing a communication session. Additional technical effects can also be realized from an implementation of the technologies disclosed herein.

Also described herein are techniques and systems for automatically sending, without user interaction, text content by an originating UE in a first RTT message of many possible RTT messages that can be sent during the communication session. This automatically-generated RTT message may be used to inform a PSAP representative of the capabilities of the originating UE (e.g., that the originating UE supports RTT calling) as a first message of the communication session. This technique is beneficial in instances where the terminal on the receiving end (e.g., a PSAP terminal) does not support early media, thereby precluding the receiving terminal from displaying RTT messages prior to establishing the communication session.

Also described herein are systems and devices comprising one or more processors and one or more memories, as well as non-transitory computer-readable media storing computer-executable instructions that, when executed, by one or more processors perform various acts and/or processes disclosed herein.

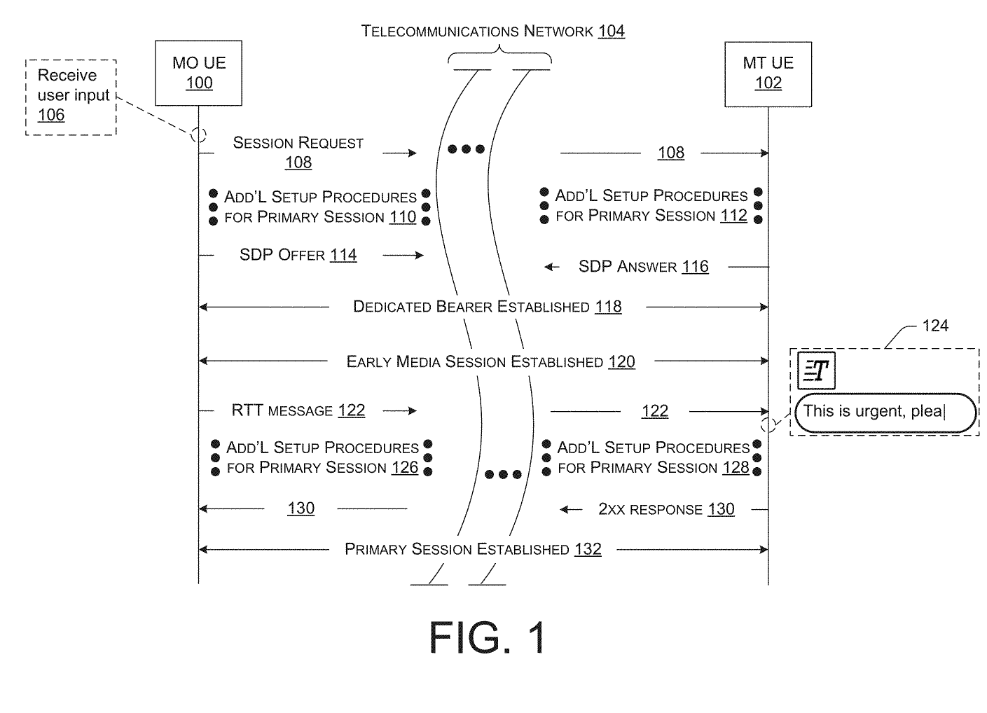

FIG. 1 is a diagram illustrating an originating UE 100 (designated as “MO UE” 100 in FIG. 1, “MO” meaning “mobile originated” or “mobile originating”) configured to send a RTT message to a terminating UE 102 (designated as “MT UE” 102 in FIG. 1, “MT” meaning “mobile terminated” or “mobile terminating”) prior to establishing a primary communication session with the terminating UE 102 over a telecommunications network 104.

In accordance with various embodiments described herein, the to “user equipment (UE),” “communication device,” “device,” “wireless communication device,” “wireless device,” “mobile device,” “terminal,” “wireless terminal,” “mobile terminal,” and “client device,” may be used interchangeably herein to describe any UE (e.g., the originating UE 100, the terminating UE 102, etc.) that is capable of transmitting/receiving data, wirelessly and/or over wired networks, using any suitable communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VoIP), Voice over LTE (VoLTE), IEEE 802.1x protocols, WiMAX, Wi-Fi, Data Over Cable Service Interface Specification (DOCSIS), digital subscriber line (DSL), and/or any future IP-based network technology or evolution of an existing IP-based network technology.

Furthermore, the originating UE 100 and the terminating UE 102 may individually be implemented as any suitable type of communication device configured to communicate over a telecommunications network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), an in-vehicle (e.g., in-car) computer, and/or any similar communication device. In addition, the originating UE 100 and the terminating UE 102 may be mobile devices, or they may be non-mobile (or situated) communication devices including, without limitation, a television (smart television), a set-top-box (STB), a game console, a desktop computer, and the like.

In general, a user can utilize a UE 100/102 to communicate with other users and associated terminals via the telecommunications network 104. A user of the originating UE 100 is often referred to herein as the “calling party,” while a user of the terminating UE 102 is often referred to herein as the “called party.” The telecommunications network 104 may represent a network comprising a plurality of network nodes disposed between the originating UE 100 and the terminating UE 102. It is to be appreciated that the telecommunications network 104 can include any suitable types, and number, of network nodes to enable the transmission of IP multimedia over the telecommunications network 104. For example, the telecommunications network 104 may include, without limitation, various radio access networks (RANs) (e.g., eNodeB, cell towers, wireless access points, etc.), an evolved packet core (EPC), as well as a multimedia telephony (MMTel) and IP Multimedia Subsystem (IMS) architecture (sometimes referred to as the “IMS core network,” the “IMS network,” the “Core Network (CN),” or the “IM CN Subsystem”). The IMS is an architectural framework defined by the 3rd Generation Partnership Project (3GPP) for delivering IP multimedia to UEs, such as the originating UE 100 and the terminating UE 102.

Various portions of the telecommunications network 104 can be maintained and/or operated by one or more service providers, such as one or more wireless carriers (sometimes referred to as “operators”), that provide IMS-based services to users (sometimes called “subscribers”) who are associated with UEs for accessing the IMS-based services to which they have subscribed. For example, a service provider may offer multimedia telephony services that allow a subscribed user to call or message other users via the telecommunications network 104 using his/her UE 100/102. A user can also utilize an associated UE 100/102 to receive, provide, or otherwise interact with various different IMS-based services by accessing the IMS core of the telecommunications network 104. In this manner, a carrier may offer any type of IMS-based service, such as, telephony services, emergency services (e.g., E911), gaming services, instant messaging services, presence services, video conferencing services, social networking and sharing services, location-based services, push-to-talk services, WiFi calling services, RTT calling services, RTT video calling services, and so on. In order to access one or more of these services, an originating UE 100 is configured to request establishment of a communication session. Although many of the examples described herein relate to the originating UE 100 accessing RTT calling services in order to setup a communication session with a voice media stream and a RTT media stream, it is to be appreciated that the originating UE 100 may request establishment of any type of communication session. In addition, RTT can be used as an add-on service for any suitable type of communication session, such as RTT video calling.

Before requesting establishment of a communication session, both the originating UE 100 and the terminating UE 102 can request registration for one or more IMS-based services while the UE's 100/102 are in idle mode. Registration can involve identifying a proxy call session control function (P-CSCF) node of the telecommunications network 104, sending a registration request via a RAN (e.g., an LTE RAN) to the identified P-CSCF node, and receiving a response indicating a result of the registration request. In instances where a legacy network (e.g., a CS network) is available to the UE 100/102, the registration procedure may be in the form of a “combined attach” procedure where the UE 100/102 performs registration for both a legacy (e.g., CS (non-LTE) network) and PS e.g., (LTE) network. By being “combined attached,” the UE 100/102 can implement fallback procedures to reattempt establishment of a communication session via a legacy network in the event that an LTE-based communication session (e.g., a VoLTE-based RTT call) fails on the LTE network. In some embodiments, when the setup of the voice component of an RTT call is successful, but the setup of the text component of the RTT call is unsuccessful, the communication session may be established as a normal voice call. In some embodiments, TTY over a CS network can be used as a fallback in the event that the setup of the text component of the RTT call is unsuccessful over a PS (e.g., LTE) network.

Session Initiation Protocol (SIP) may be used for transmitting SIP messages in the signaling portion of the communication session, as opposed to the data or media stream portion of the communication session. Such SIP messages may include, without limitation, registration messages, communication session messages, and the like, which are sent to the IMS core of the telecommunications network 104, and received therefrom. SIP is a signaling protocol that can be used to establish, modify, and terminate communication sessions over packet networks, and to authenticate access to IMS-based services. As used herein, a “SIP request” is a message that is sent from a UE 100/102 to the IMS core of the telecommunications network 104 using SIP protocol, and a “SIP response” is a message that is sent from the IMS core of the telecommunications network 104 to a UE 100/102 using SIP protocol.

When a user of the originating UE 100 wants to establish a communication session (e.g., a RTT call), the user may provide user input to the originating UE 100. Thus, FIG. 1 shows that the originating UE 100 receives user input at 106. The user input received at 106 can be provided in any suitable form known to a person having ordinary skill in the art, such as user input in the form of a voice command that is captured by a microphone of the originating UE 100 (e.g., “call Bob's cell”), user input in the form of touch input that is received via a touch screen of the originating UE 100, or that is received via physical keys or a keypad of the originating UE 100, user input in the form of a gesture that is captured by a camera of the originating UE 100, and so on. In an example, the user may initiate establishment of a primary communication session by providing touch-based user input to a touch screen of the originating UE 100, such as by dialing a phone number or by selecting a contact from a list of contacts presented on the display of the originating UE 100. It is to be appreciated that the originating UE 100 may be configured to present various options to the user for initiating any type of communication session supported by the originating UE 100, such as a normal voice call (e.g., a VoLTE call), an RTT call, a video call, and so on. If the user invokes a RTT calling function (e.g., by selecting a “RTT call” soft button presented on the touch screen of the originating UE 100), the to-be-established communication session may be a RTT call that combines voice and RTT media streams.

In response to receiving the user input at 106, the originating UE 100 may attempt to establish a primary communication session. To establish the requested communication session, the originating UE 100 can send a session request 108 over the telecommunications network 104 (e.g., to the IMS core). The session request 108 can comprise a SIP message using the SIP INVITE method to request that a primary communication session be established with a terminating UE 102. Ultimately, the session request 108 can be forwarded to the terminating UE 102, as shown in FIG. 1. Accordingly, the terminating UE 102 receives the session request 108 (e.g., in the form of a SIP INVITE) requesting to establish a primary communication session.

The session request 108 may include a header that contains information indicating that the originating UE 100 supports early media, such as RTT early media. This information can be used by particular nodes of the telecommunications network 104 and/or by the terminating UE 102 to determine that the originating UE 100 is not only an RTT-capable device, but a device that also supports RTT early media. A device that supports RTT early media can exchange RTT messages with another device during an early media communication session, prior to establishing the primary communication session, and while the primary communication session is being setup. The information included in the header can include one or more feature tags, at least one of the feature tags indicating that the originating UE 100 supports RTT early media. For example, a feature tag with a Feature_tag value=‘sip.RTTearlymedia’ may be included in a session request 108 header to indicate that the originating UE 100 supports RTT early media. It is to be appreciated that this capability (e.g., RTT early media) can additionally be sent by the originating UE 100 during the registration procedure, such as by including the aforementioned feature tag in a SIP REGISTER message, prior to the originating UE 100 receiving the user input at 106.

In response to sending the session request 108, the originating UE 100 can perform additional setup procedures 110 for establishing the primary communication session. Similarly, in response to receiving the session request 108, the terminating UE 102 can perform its own additional setup procedures 112 for establishing the primary communication session from the terminating UE's 102 perspective. Initiating additional setup procedures (e.g., the setup procedures 110 and 112) is sometimes referred to herein as “initiating a session setup.” As will be described in more detail below, the additional setup procedures 110 and 112 that commence after the transmission and receipt of the session request 108 can comprise various actions and message transmissions by and between the UEs 100 and 102, and by and between each UE 100/102 and various network nodes of the telecommunications network 104 (e.g., IMS nodes). FIG. 1 illustrates an example where both the originating UE 100 and the terminating UE 102 support RTT early media. In this example, the additional setup procedures 112 performed by the terminating UE 102 may include, among other setup procedures, sending a response that contains information indicating that the terminating UE 102 supports early media, such as RTT early media. This information may be provided in a header of a response (e.g., a response using the SIP OPTIONS method) sent by the terminating UE 102 after receiving the session request 108. In this manner, the terminating UE 102 can send a message (e.g., using the SIP OPTIONS method) to discover whether the originating UE 100 supports RTT early media, and may include, in the header of that message, its own capabilities, such as whether the terminating UE 102 also supports RTT early media. Again, this information can include one or more feature tags, at least one of the feature tags indicating that the terminating UE 102 supports RTT early media.

It is to be appreciated that capability discovery with respect to whether a UE (e.g., the originating UE 100, the terminating UE 102) supports RTT early media or not may be exchanged between the UEs 100 and 102 in other ways, without departing from the basic characteristics of the techniques and systems described herein. For instance, the originating UE 100 may send a SIP OPTIONS message in response to receiving the user input at 106, but separately from the session request 108, where the SIP OPTIONS message contains information indicating whether the originating UE 100 supports early media, such as RTT early media. The terminating UE 102 in this example may respond with a 200 (OK) message, which may include its own capability information, indicating whether the terminating UE 102 supports early media, such as RTT early media, or the terminating UE's 102 capabilities may be sent in a SIP OPTIONS message from the terminating UE 102. As another example, capability exchange can occur with the use of a presence service. For example, one or both of the UE's 100 and/or 102 may publish capabilities, such as whether they individually support RTT early media, to a presence server. The other or both of the UE's 100 and/or 102 may also subscribe to the capability info that is published by the other UE. Once a UE, such as the terminating UE 102, subscribes to the presence information of the other UE, such as the originating UE 100, the capabilities (e.g., RTT early media supported) published by the other UE are known to the subscribing UE. This presence server based capability exchange can be done before the originating UE 100 receives the user input at 106 and before it sends the session request 108.

Eventually, during the session setup of the primary communication session, the originating UE 100 can send a Session Description Protocol (SDP) offer 114 in order to negotiate initialization parameters for text content that is to be transmitted during an early media communication session (i.e., prior to establishing the primary communication session). SDP is a format for describing streaming media initialization parameters. SDP does not deliver media itself, but is used between end points for negotiation of media type, format, and associated properties thereof. The terminating UE 102 may send a SDP answer 116 in order to negotiate the initialization parameters for text content that is to be transmitted during the early media communication session. The SDP answer 116 may be sent in response to the SDP offer 114.

As shown in FIG. 1, a dedicated bearer (e.g., a dedicated evolved packet system (EPS) bearer) may be established at 118 for the early media communication session. Subsequently, the early media communication session may be established at 120, and, thereafter, the UEs 100/102 may commence the exchange of RTT messages while the primary communication session is still being setup.

Accordingly, the originating UE 100 may send text content in a RTT message 122, as shown in FIG. 1. The RTT message 122 may be sent using Real-time Transport Protocol (RTP) and user datagram protocol (UDP) to carry text content of the WIT media stream in packets that can be transmitted at a desired frequency (e.g., time sampled) to resemble real-time transmission. For example, the originating UE 100 may send RTT packets at a particular frequency (e.g., every second) in order to resemble a real-time conversation and near instantaneous display of the text content on the terminating UE 102, as the calling party types a message on the originating UE 100. The Internet Engineering Task Force (IETF) Request for Comments (RFC) 4103 sets forth a technical specification for carrying text content of an RTT message in RIP packets. The Alliance for Telecommunication Industry Solutions (ATIS) 0700029 sets forth an additional technical specification for certain aspects of the mobile device behavior for handling RTT to facilitate communication between mobile devices (including emergency services) across multiple Commercial Mobile Service Providers (CMSPs). Unless otherwise specified, text content of an RTT message, such as the RTT message 122, can be transmitted according to the IETF RFC 4103 and/or ATIS 0700029 specifications as part of a RTT media stream. The RTT message 122 can be sent during the early media communication session, prior to establishing the primary communication session (e.g., a primary RTT call), and while a remainder of the session setup for the primary communication session is carried out.

It is to be appreciated that the text content included in the RTT message 122 can be user-generated text content, user-selected, or machine-generated (i.e., without user interaction). The calling party can create user-generated text content, on-the-fly, by providing appropriate user input to an input mechanism (e.g., a microphone(s), a text entry field on a touchscreen, etc.) enabled on the originating UE 100. The originating UE 100 may enable such an input mechanism for inputting user-generated text content after the early media session is established at 120.

Alternatively, the calling party can select predefined text content that is displayed on the display of the originating UE 100 for selection by the user, which causes the user-selected text content to be inserted in the RTT message 122. For example, stored text content may be available to the originating UE 100, and the originating UE 100 may retrieve and display at least some of the stored text content for the user to select for the RTT message 122. As an example, available text content for user selection may include the following: “This is urgent, please pick up!” Presenting predefined text content for user selection can allow for even quicker transmission of RTT messages, seeing as how there is a limited window of time until the setup of the primary communication session is resolved (e.g., successfully connected, directed to voicemail, etc.).

Alternatively, the text content of the RTT message 122 can be selected, by the originating UE 100, without any user interaction, from stored text content available to the originating UE 100. In other words, the RTT message 122 may be automatically generated by the originating UE 100 and sent by the originating UE 100 without any user interaction other than the received user input at 106 to request the establishment of the communication session. This may be useful for various reasons, as will be described in more detail below.

However the text content is generated, the terminating UE 102 may receive the RTT message 122 in real time, as the calling party is typing the text content of the RTT message 122. As used herein, “real-time” or “substantially real-time” means that a time period measured from the moment text content is input on a source device to a moment the same text content is displayed on a target/receiving device is sufficiently short to experience, at the target/receiving device a display of text content as the calling party is entering the text content at the source device. This period of time may be on the order of a few seconds, and it is recognized that there will be some amount of time delay between inputting text content on the source device and displaying the text content on the target/receiving device. Accordingly, the terminating UE 102 may display the RTT message 122 at 124 in real-time. FIG. 1 shows an example where the calling party is in the midst of typing the phrase “This is urgent, plea . . . .”

FIG. 1 further illustrates that, after the transmission and receipt of the RTT message 122, additional setup procedures 126 and 128 may be performed by the originating UE 100 and by the terminating UE 102, respectively, in an effort to establish the primary communication session. It is to be appreciated that the arrangement of the signaling in FIG. 1 is not necessarily meant to depict a particular order of the signaling that is to take place during the setup of a primary communication session. With this in mind, some or all of the additional setup procedures 110/112/126/128 may occur before, during, or after any of the other specific signaling that is shown in FIG. 1. That said, the additional setup procedures 110/112/126/128 are to represent setup procedures that occur after the session request 108 (e.g., a SIP INVITE) and a final 2xx response 130.

To this end, the additional setup procedures 110/112/126/128 may represent any type of setup procedures, in any suitable number, that may be performed to setup and establish the primary communication session. Some examples of the additional setup procedures 110/112/126/128 include, without limitation, sending/receiving a session progress message (sometimes called a “183 response”), establishing a radio resource control (RRC) connection with a preferred RAT (e.g., an LTE RAT), sending/receiving a 100 Trying message (indicating the session request 108 has been received at the terminating UE 102), sending/receiving a 180 Ringing message (indicating that a terminating party of the terminating UE 102 is being alerted), sending/receiving an UPDATE message, sending/receiving various “ACK” message (e.g., a PRACK message), and so on. Thus, the additional setup procedures 110/112/126/128 may represent various setup procedures that occur during particular setup phases for a communication session, such as a pre-alerting phase, an alerting phase, and so on. A person having ordinary skill in the art will readily recognize that additional setup procedures 110/112/126/128 are not limited to the examples described herein, and that other (e.g., different and/or additional) setup procedures may be performed in order to setup the primary communication session over a telecommunication network 104. Furthermore, some of the example setup procedures described herein may be omitted or unnecessary for setting up a primary communication session.

In some embodiments, at least some of the signaling involved in establishing the early media communication session at 120 can be the same signaling used for setting up and establishing the primary communication session at 132. In some embodiments, the signaling involved in establishing the early media communication session at 120 may be separate and independent form the signaling used for setting up and establishing the primary communication session at 132. As an example, the SDP offer 114 and the SDP answer 116 may be utilized to negotiate initialization parameters for media streams of both the early media communication session and the primary communication session without sending a separate SDP offer and SDP answer for the primary communication session. As another example, the dedicated bearer that is established at 118 may be utilized for both the early media communication session and the primary communication session, rather than establishing a separate dedicated bearer for the primary communication session. Thus, the dedicated bearer assigned to the RTT media stream of the early media communication session may, in some instance, be a same dedicated bearer that is assigned to a voice media stream for the primary communication session.

FIG. 1 illustrates that the terminating UE 102 can send a final 2xx response 130 (e.g., 200 (OK)) to establish the communication session at 132, assuming the setup of the primary communication session is successful. It is to be appreciated that, in the event that there is an issue with setting up the primary communication session, other types of final responses may be transmitted to resolve the primary session setup, such as a 4xx—client failure, a 5xx—server failure, or a 6xx—global failure. The primary communication session setup is not complete unless and until the terminating UE 102 transmits a final response (e.g., a 2xx response 130, a 4xx response, a 5xx response, a 6xx response, etc.). Furthermore, the primary communication session is not established at 132 unless and until the terminating UE 102 transmits a final response in the form of a 2xx response 130 (e.g., 200 (OK)).

Thus, FIG. 1 illustrates a signaling flow to enable “early” exchange of text content in an RTT message 122, meaning the exchange of text content in a RTT message 122 occurs during setup of, and prior to establishing, the primary communication session at 132. FIG. 1 shows an example where the RTT message is sent during an early media communication session. For example Alice (associated with the originating UE 100) calls Bob (associated with the terminating UE 102) with an urgent matter. Alice's device 100 has RTT early media capability, and sends the text content “This is urgent, please pick up!” in the RTT message 122 to Bob when Bob's device 102 is still ringing. The text content of the RTT message 122 can be generated by Alice on-the-fly (e.g., user-generated text content), selected by Alice from selectable text content available to the originating UE 100, or generated by the UE 100 itself, in which case the text content might be different (e.g., “This is a RTT call”). Bob sees the text content of the RTT message 122 in real time and picks up the phone right away, and Bob and Alice start the conversation using any media available in the communication session (e.g., RTT, voice, video, etc.). As mentioned, several downstream technical effects can be realized by enabling the early transmission of text content in a RTT message 122, as depicted in FIG. 1. For instance, the text content of the RTT message 122 provides contextual information to the called party (i.e., the user associated with the terminating UE 102 in FIG. 1), which can better inform the called party as to various things relating to the incoming request. FIG. 1 shows an example where an RTT message 122 is used to convey the urgency of the primary communication session (e.g., “This is urgent, please pick up!”). Without such an early RTT message 122, the calling party may have to make repeated attempts to establish the primary communication session before the called party finally answers, consuming unnecessary resources (e.g., bandwidth, processing, etc.) in the process.

Although FIG. 1 shows an example where the RTT message 122 is used to convey an urgency of the primary communication session, an early RTT message 122 can additionally, or alternatively, indicate the identity of the calling party (e.g., “This is Henry”), and/or the purpose of the call (e.g., “I'm calling about our meeting the other day”). A machine-generated RTT message 122 can be sent without any user interaction to inform the called party as to the type of request they are receiving (e.g., “This is an RTT call”). This may let the called party know that, upon accepting the request to establish the primary communication session, he/she may type RTT messages in addition to talking on the terminating UE 102. This may be useful at the early stages of adopting/implementing RTT on UEs so that users can be better educated as to sessions that are RTT-based sessions as opposed to non-RTT-based sessions.

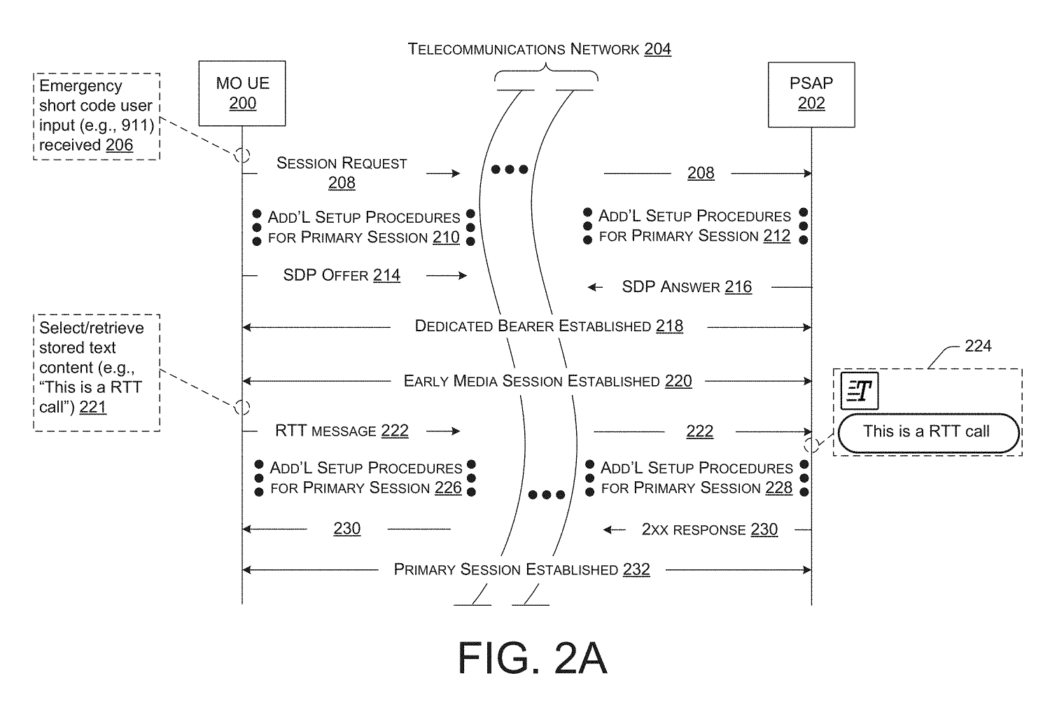

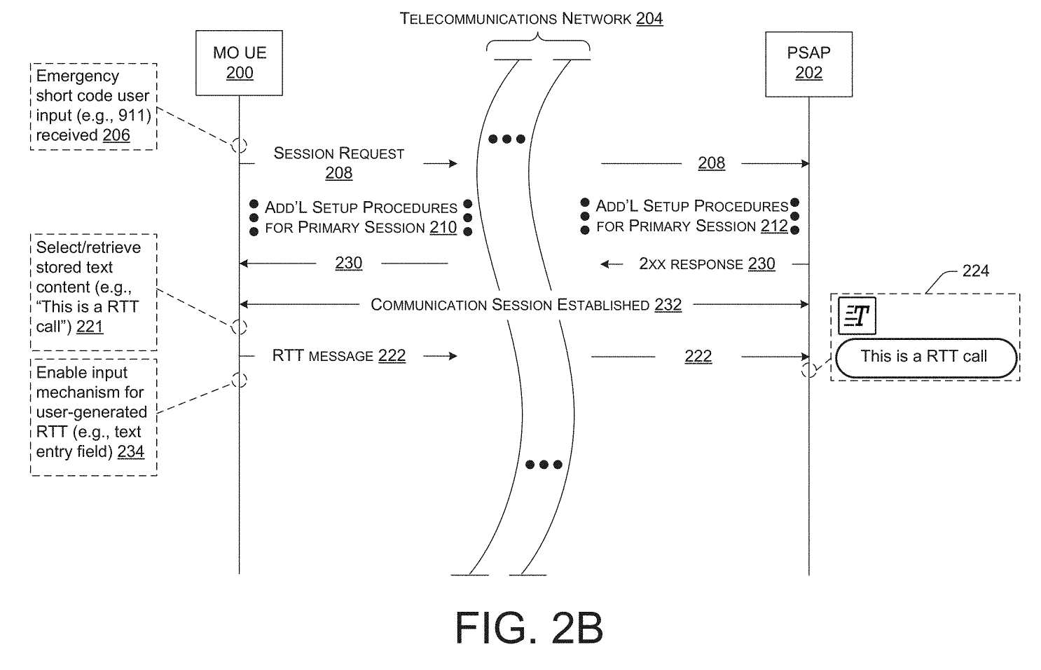

FIG. 2A is a diagram illustrating an originating UE 200 configured to send a RTT message to a Public Safety Answering Point (PSAP) 202 prior to establishing a primary communication session with the PSAP 202 over a telecommunications network 204. The PSAP 202 (and other PSAPs described herein) may be “RTT-capable” by being configured to receive and send RTT messages from and to UEs over a telecommunications network. Such PSAPs may be configured to implement Next Generation (NG)-911 features to enable receipt of RTT messages (e.g., in an early media session). FIG. 2A illustrates a scenario where a user is experiencing an emergency situation and dials an emergency short code (e.g., 911 in the United States) to be connected to an emergency operator who may assist the user during the emergency. Accordingly, the originating UE 200 may receive user input at 206 in the form of an emergency short code, which causes a request for the primary communication session to be routed to an appropriate (e.g., nearest) PSAP 202. It is to be appreciated that the calling party may invokes a RTT calling function (e.g., by selecting a “RTT call” soft button presented on the touch screen of the originating UE 100) to establish the emergency call as an RTT call. Alternatively, the calling party may invoke a normal calling function to establish a normal (e.g., VoLTE) call. In some embodiments (and not just in the emergency 911 scenario), the invocation of a normal calling function may automatically initiate an RTT call by requesting the establishment of a primary communication session that combines voice and RTT media streams.

In response to receiving the user input at 206, the originating UE 200 may attempt to establish a primary communication session with the appropriate PSAP 202 by sending a session request 208 over the telecommunications network 204. The session request 208 can comprise a SIP message using the SIP INVITE method to request that a primary communication session be established with the PSAP 202. The PSAP 202 may receive the session request 208 (e.g., in the form of a SIP INVITE) requesting to establish a primary communication session. As used herein “PSAP” 202 may represent a terminal at the PSAP 202.

Some existing PSAP terminals may not support RTT calls or be configured to process incoming RTT calls with RTT technology. In this case, one or more nodes of the telecommunications network 204 may be configured to transcode RTT signaling and/or messaging into TTY format, thereby enabling the PSAP to handle the incoming session request 208 as a TTY call. To this end, although the PSAP 202 receives the session request 208 from an originating UE 200 that supports RTT calling, the session request 208 received by the PSAP 202 may nevertheless be transcoded from RTT-to-TTY before receipt by the PSAP 202. Accordingly, a PSAP 202 representative (e.g., a 911 operator) may not know whether the incoming call is from a TTY device or a RTT device.

The session request 208 may include a header that contains information indicating that the originating UE 200 supports early media, such as RTT early media. In response to sending the session request 208, the originating UE 200 can perform additional setup procedures 210 for establishing the primary communication session. Similarly, in response to receiving the session request 208, the PSAP 202 can perform its own additional setup procedures 212 for establishing the primary communication session from the PSAP's 202 perspective. FIG. 2A illustrates an example where both the originating UE 200 and the PSAP 202 support RTT early media. In this example, the additional setup procedures 212 performed by the PSAP 202 may include, among other setup procedures, sending a response that contains information indicating that the PSAP 102 supports early media, such as RTT early media. This information may be provided in a header of a response sent by the PSAP 202 after receiving the session request 208.

The originating UE 200 can send a SDP offer 214, and the PSAP 202 may send a SDP answer 216 in order to negotiate the initialization parameters for text content that is to be transmitted during an early media communication session. The SDP answer 216 may be sent in response to the SDP offer 214.

A dedicated bearer may be established at 218 for the early media communication session. Subsequently, the early media communication session may be established at 220, and, thereafter, the UEs 100/102 may commence the exchange of RTT messages while the primary communication session is still being setup.

Accordingly, the originating UE 200 may send text content in a RTT message 222, as shown in FIG. 2A. The RTT message 222 can be sent during the early media communication session, prior to establishing the primary communication session (e.g., a primary RTT call), and while a remainder of the session setup for the primary communication session is carried out. FIG. 2A illustrates an example where the text content of the RTT message 222 is selected (or retrieved), by the originating UE 200, without any user interaction, at 221. The text content selected at 221 may be selected from stored text content available to the originating UE 200, such as text content stored in local memory of the originating UE 200, or remote/external memory accessible to the originating UE 200. In other words, the RTT message 222 may be automatically generated by the originating UE 200 at 221 and sent by the originating UE 200 without any user interaction other than the received user input at 206 to request the establishment of the communication session. In the example of FIG. 2A, the text content of the RTT message 222 indicates that “This is an RTT call.” When the PSAP 202 receives the RTT message 222 and displays the text content of the RTT message 222 in real-time at 224, a PSAP 202 representative may be informed of the capabilities of the originating UE 200 (e.g., that the originating UE 200 supports RTT calling, as opposed to exclusively supporting TTY). This is beneficial due to the aforementioned transcoding of RTT calls into TTY calls at the PSAP 202, which may occur in some instances. Thus, when PSAP 202 equipment supports RTT early media, an early RTT message 222 may be used to inform a PSAP 202 representative that the 911 call is coming from an RTT-capable device 200.

As shown in FIG. 2A, the signaling during session setup of the primary communication session may further include additional setup procedures 226 and 228 performed by the originating UE 200 and by the PSAP 202, respectively. Again, the additional setup procedures 210/212/226/228 may represent any type of setup procedures, in any suitable number, that may be performed to setup and establish the primary communication session.

As with the example of FIG. 1, at least some of the signaling involved in establishing the early media communication session at 220 can be the same signaling used for setting up and establishing the primary communication session at 232. In some embodiments, the signaling involved in establishing the early media communication session at 220 may be separate and independent form the signaling used for setting up and establishing the primary communication session at 232. FIG. 2A illustrates that the PSAP 202 can send a final 2xx response 230 (e.g., 200 (OK)) to establish the communication session at 232, assuming the setup of the primary communication session is successful.

Thus, FIG. 2A illustrates a signaling flow to enable “early” exchange of machine-generated text content in an RTT message 222 to a PSAP 202 during an emergency communication session. This may be utilized by personnel at the PSAP 202 to understand that the originating UE 200 is a RTT-capable device, as opposed to a TTY device.

FIG. 2B is a diagram illustrating an originating UE 200 configured to send an automatically-generated RTT message to a PSAP 202 as the first RTT message sent to a PSAP during a primary communication session with the PSAP 202. That is, the difference between the example of FIG. 2A and FIG. 2B is a temporal difference in that the RTT message 222 is sent after the primary communication session is established at 232 instead of before. This may be useful in a scenario where the PSAP 202 does not support early media, such as early RTT media. Thus, for the sake of brevity, similar signaling/operations to those described in FIG. 2A will not be repeated with respect to FIG. 2B. It is noted, however, that the RTT message 222 in the example of FIG. 2B may be sent before the originating UE 200 enables (at 234) an input mechanism for the calling party to create user-generated text content for transmission in RTT messages during the communication session. The input mechanism enabled by the originating UE 200 can include a text entry field on a touch screen display of the originating UE 200 for the calling party to type text content, or any other suitable input mechanism (e.g., a microphone(s)). Thus, the originating UE 200 may prevent the calling party from sending any user-generated text content in an RTT message until the first RTT message 222 has been sent to the PSAP 202. Thus, the PSAP 202 receives a RTT message 222 (e.g., “This is an RTT call”) before the calling party starts typing any subsequent RTT messages.

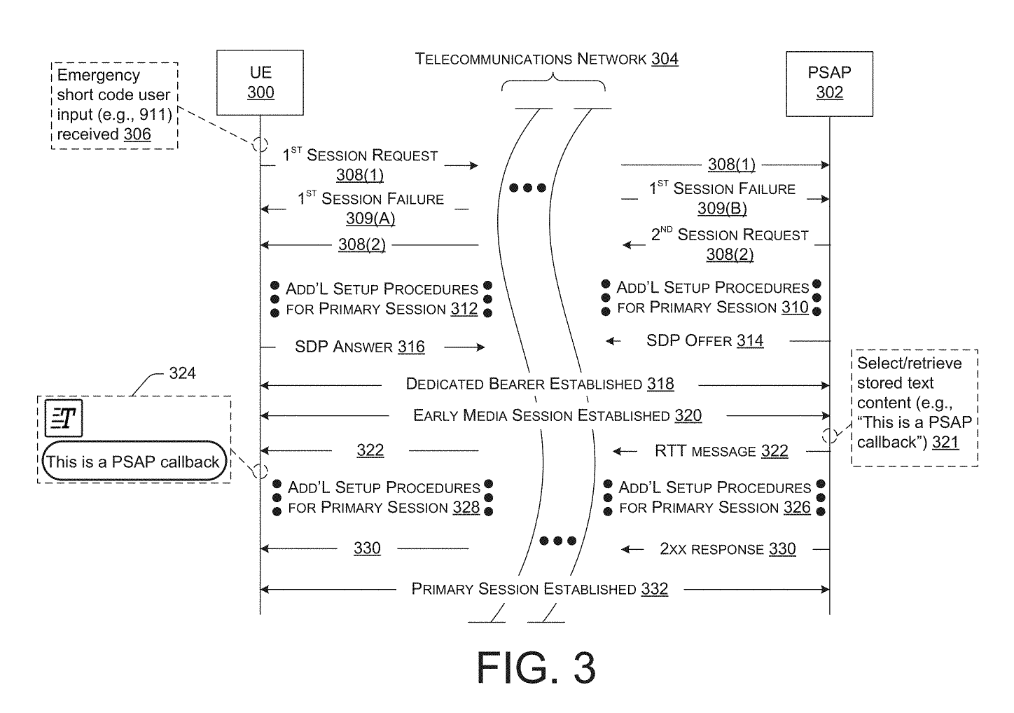

FIG. 3 is a diagram illustrating a UE 300 configured to receive a RTT message from a PSAP 302 after a failure of an initial communication session, and prior to establishing a subsequent, primary communication session with the PSAP 302 over a telecommunications network 304. FIG. 2A illustrates a scenario the user of the UE 300 tried to make an emergency call (e.g., a 911 call), but the initial session either wasn't successfully setup or dropped after it was established (e.g., due to poor radio conditions), and the PSAP 302 automatically calls the user back, and utilizes an early RTT message 322 to indicate that the callback is from the PSAP 302. This may better inform the user as to who is calling the user, as opposed to an unidentified number being presented with an incoming call from the PSAP 302.

Accordingly, the UE 300 (acting as an originating UE) may receive user input at 306 in the form of an emergency short code, which causes a request for the primary communication session to be routed to an appropriate (e.g., nearest) PSAP 302. In response to receiving the user input at 306, the UE 300 may attempt to establish a first primary communication session with the appropriate PSAP 302 by sending a first session request 308(1) over the telecommunications network 304. The first session request 308(1) can comprise a SIP message using the SIP INVITE method to request that a primary communication session be established with the PSAP 302. The PSAP 302 may receive the first session request 308(1) (e.g., in the form of a SIP INVITE) requesting to establish a primary communication session.

If an issue occurs in setting up the first primary communication session, however, the UE 300 and the PSAP 302 may respectively receive a failure response 309(A) and 309(B), which may indicate that the setup procedures have been terminated. The failure responses 309(A)/(B) can include a 5xx response, for example. Alternatively, the first primary communication session may have been successfully established, but subsequently dropped (e.g., due to poor radio conditions). In either case, responsive to the failure response 309(B), the PSAP 302 may initiate a callback to the user of the UE 300 to re-establish a communication session. Thus, the PSAP 302 can send a second session request 308(2), and the UE 300 may receive the second session request 308(2). Thereafter, the procedures and signaling are similar to those described with respect to FIG. 2A, except the direction of the signal flow is reversed because the PSAP 302 is calling the UE 300 instead of the UE 200 calling the PSAP 202. In the example of FIG. 3, however, the PSAP can send an early RTT message 322 with text content such as “This is a PSAP callback” or “This is the 911 operator.” In this manner, the user of the UE 300 is better informed, as compared to receiving a call from an unidentified number. For example, Alice's (associated with the UE 300) emergency (e.g., 911) call dropped on the first attempt. While Alice hesitates about whether to call 911 again, Alice receives a phone call from a number she doesn't recognize. While the UE 300 is ringing, however, Alice sees that her UE 300 displays a RTT message 322 with the text “This is a PSAP callback” (or similar text content), and Alice answers the call, knowing that it is a 911 operator trying to re-establish the dropped call.

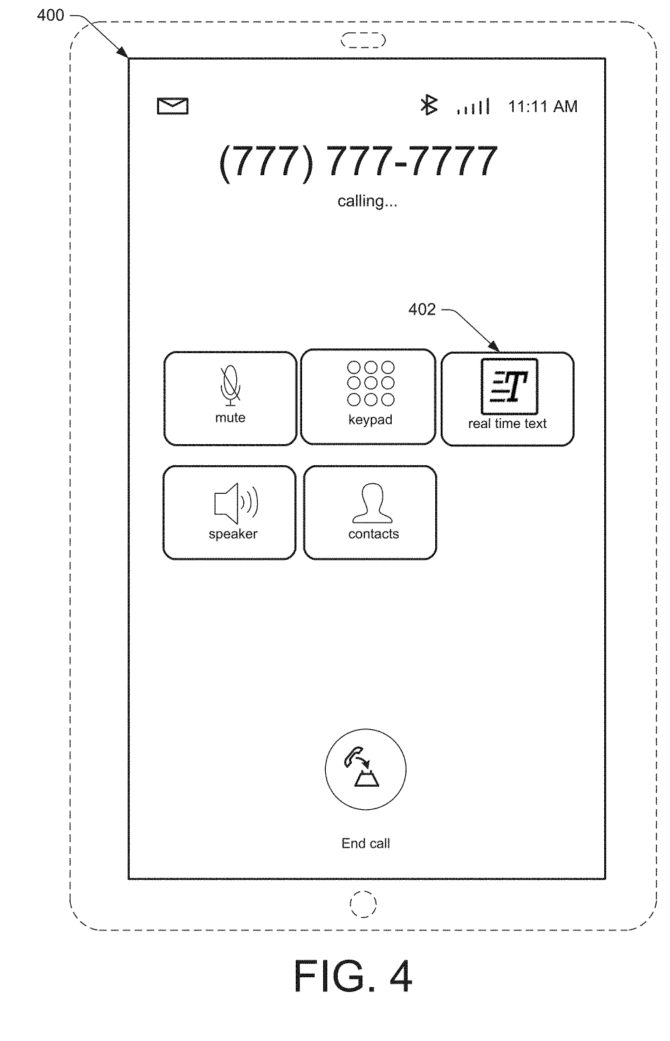

FIG. 4 illustrates an example user interface 400 of an originating UE, such as the originating UE 100, that is displayed during setup of a communication session. The user interface 400 may be invoked, for example, by a user of the originating UE 100 having opened a voice calling application on the originating UE 100, dialed a number, and selected an element on a touch screen of the originating UE 100 that causes a session request 108 to be sent to the appropriate terminal of the called party. For example, the user interface 400 may represent a screen that is presented on the originating UE 100 in response to receiving the user input 106 in FIG. 1, but prior to sending the RTT message 122. FIG. 4 shows that the calling party is in the midst of calling the phone number 777-777-7777, and the called party has not yet answered.

Whether the user selected a normal calling function or a RTT calling function to invoke the user interface 400, the user interface 400 may optionally include a RTT selection element 402 that, upon selection, enables an input mechanism for allowing the user to send an early RTT message 122 during setup of, and prior to establishing, a primary communication session (e.g., a RTT call).

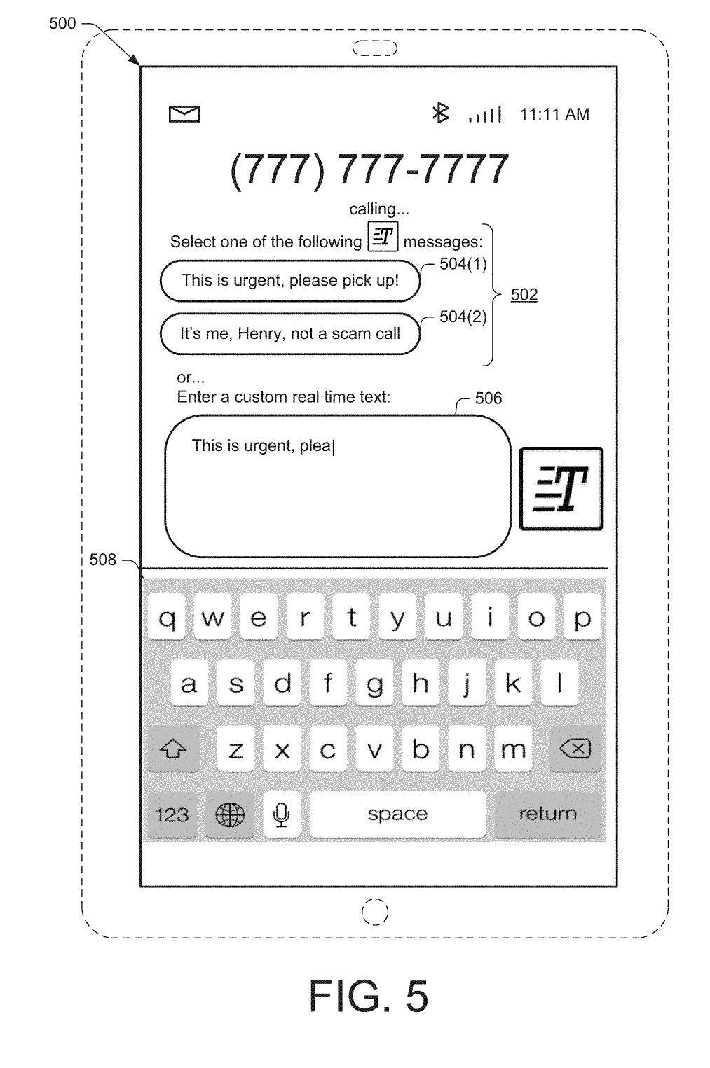

FIG. 5 illustrates an example user interface 500 of an originating UE 100 that is displayed during setup of a communication session. The user interface 500 may be invoked, for example, by a user of the originating UE 100 having selected the RTT selection element 402 shown in FIG. 4. Alternatively, the user interface 500 may be invoked in response to the user having selected an element on a touch screen of the originating UE 100 that causes a session request 108 to be sent to the appropriate terminal of the called party, without presenting the user interface 400. That is, the user interface 500 may be displayed in response to the providing a command as user input to initiate a primary communication session (e.g., a RTT call). Furthermore, the user interface 500 may be displayed after an early media session has been established for exchanging early RTT messages, but prior to establishing the primary communication session.

The user interface 500 may present, in a first region 502, selectable text content 504 for selection by the user. FIG. 5 shows two examples of selectable text content 504 that may be available to the originating UE 100 (e.g., stored in local memory, or remote/external memory accessible to the originating UE 100). A first selectable text content 504(1) says “This is urgent, please pickup up!” while a second selectable text content 504(2) says “It's me, Henry, not a scam call.” These are merely examples of text content that may be predefined and available to the user for selection. The selectable text content 504 may be default text content created by a manufacturer of the UE 100 and/or the software (e.g., operating system) of the UE 100, and/or text content defined by the user. For example, the user may have, at some earlier point in time, created text content in a settings menu, and saved the text content for display during the setup of a primary communication, as shown in FIG. 5. Selection of one of the options 504(1) or 504(2) causes the corresponding text content to be inserted into a text input mechanism 506, such as a text entry field. The text input mechanism 506 is sometimes referred to herein as a “RTT conversation window” 506, which is displayed in the user interface 500 and is selectable by the user of the UE 100 for inputting text content. Upon insertion into the text input mechanism 506, the text content is transmitted, in real-time, to the terminating UE 102, as described herein.

A user may also type out user-generated text content in the free form text input mechanism 506 using a soft keyboard 508 and/or using a microphone as an input mechanism with voice recognition. Thus, a user of the originating UE 100 is able to create user-generated text content, and/or select from available text content 504, using the user interface 500. Because the user interface 500 is presented during the setup of the primary communication session, and prior to establishing the primary communication session, the user is able to send early RTT messages, such as the RTT message 122, to the calling party before the calling party accepts the request to establish the primary communication session.

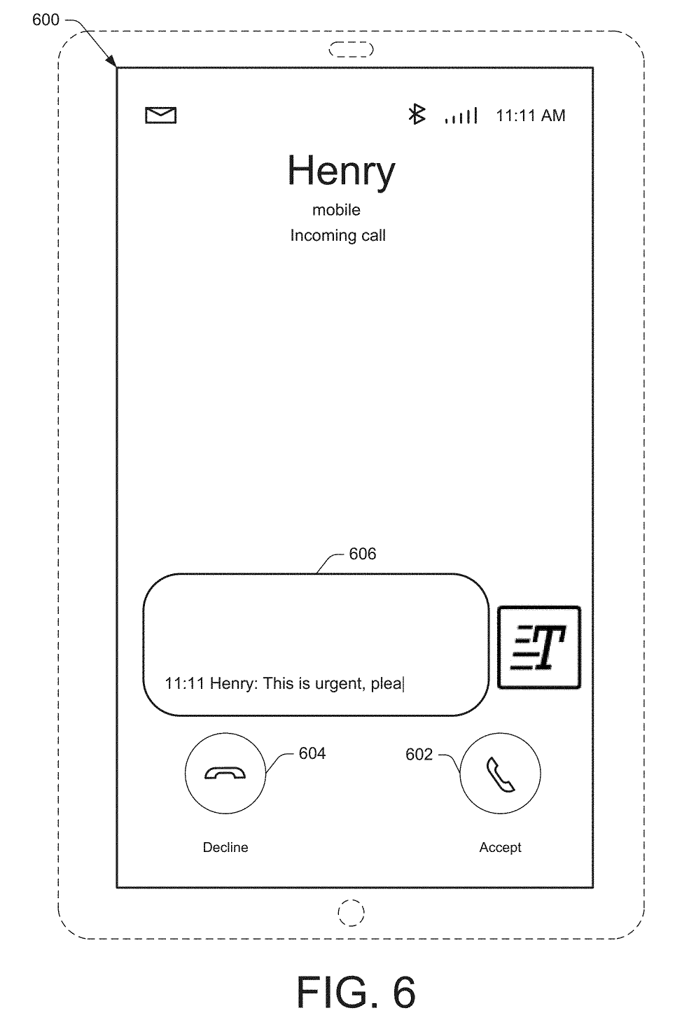

FIG. 6 illustrates an example user interface 600 of a terminating UE, such as the terminating UE 102, that is displayed during setup of a primary communication session. The user interface 600 may be invoked responsive to receipt of the session request 108, after receipt of at least some text content of an RTT message 122, and before establishing the primary communication session. The example of FIG. 6 shows that a called party is receiving an incoming call (e.g., a RTT call) from a calling party named “Henry”. Before accepting the incoming call by selection of the “accept” soft button 602, or declining the incoming call by selection of the “decline” soft button 604 (either of which would resolve the setup of the primary communication session), the terminating UE 102 receives text content of a RTT message 122 and displays the text content of the RTT message 122 in a RTT display area 606, which may be proximate (e.g., adjacent) to the “accept” and “decline” soft buttons 602 and 604, respectively. In this way, the text content of the RTT message 122 is prominently and conspicuously displayed, and it is unlikely that the called party will not see the text content as a result. This is an improvement over the utilization of traditional text messaging technologies, such as SMS text because it is closely aligned with the incoming call and is not subject to the latency of SMS text. The user interface 600 may be configured to receive user-generated text content from the called party responsive to the called party providing user input (e.g., contacting a touch screen) within the RTT display area 606. That is, the RTT display area 606 may double as an input mechanism to allow the called party to type, insert, or otherwise cause to be inserted, text content into the RTT display area 606. In this manner, the parties to the to-be-established primary communication session may carry out a conversation via early RTT messaging. As an example, if the called party contacts the touch screen of the terminating UE 102 within the RTT display area 606, a user interface similar to the user interface 500 of FIG. 5 may be invoked on the display of the terminating UE 102, possibly with the addition of the “accept” and “decline” soft buttons 602 and 604.

It is to be appreciated that the user interfaces 400, 500, and 600 are merely exemplary for illustrative purposes, and that other similar user interfaces may be presented for the various other scenarios described herein. For example, a user interface of a PSAP 202 terminal may be presented similarly to FIG. 6, albeit without necessarily presenting an identified caller (e.g., presenting a telephone number instead of “Henry”), and possibly with other selectable elements for accepting and/or declining the incoming request.

The processes described in this disclosure may be implemented by the architectures described herein, or by other architectures. These processes are illustrated as a collection of blocks in a logical flow graph. Some of the blocks represent operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order or in parallel to implement the processes. It is understood that the following processes may be implemented on other architectures as well.

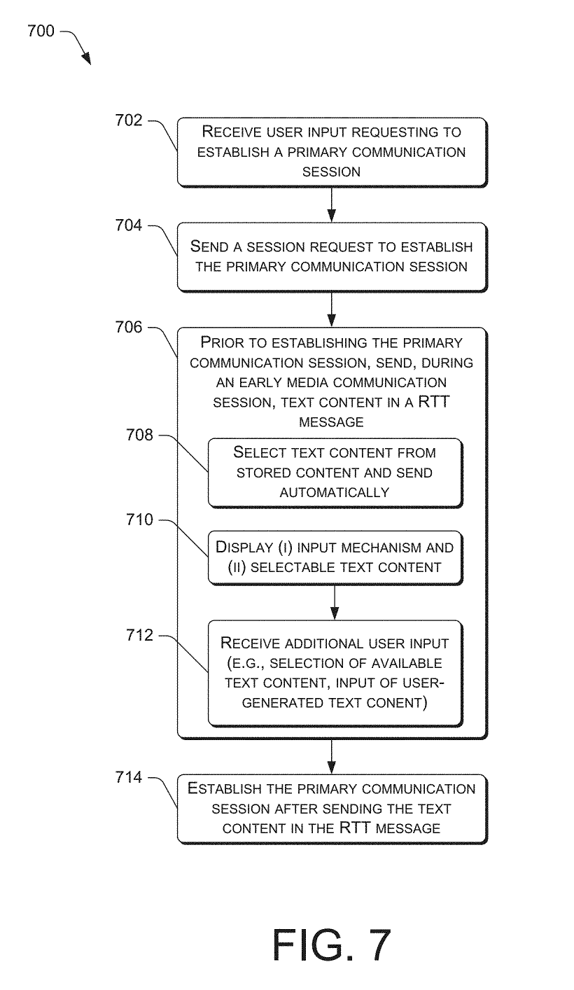

FIG. 7 illustrates a flowchart of an example process 700 for early transmission of a RTT message 122/222/322 during setup of the primary communication session. The process 700 may be implemented by an originating UE, such as the originating UE 100 or 200 of FIGS. 1 and 2A. The process 700 is described, by way of example, with reference to the previous figures.

At 702, an originating UE 100/200 may receive user input requesting to establish a primary communication session. As described, the user input may be provided in various ways via any suitable input mechanism enabled by the originating UE 100/200. In the case of a non-emergency call, the user input may correspond a number of another subscriber of IMS-based services, the subscriber being associated with a terminating UE 102. In the case of an emergency call, the user input may be in the form of an emergency short code (e.g., 911 in the United States).

At 704, the originating UE 100/200 may send, over a telecommunications network 104/204, a session request 108/208 to establish the primary communication session. This may be in the form of a SIP INVITE. In a non-emergency context, the session request 108 may be ultimately forwarded to a terminating UE 102. In an emergency context, the session request 208 may be ultimately forwarded to a PSAP 202.

At 706, prior to establishing the primary communication session, and during an early media communication session, the originating UE 100/200 may send text content in a RTT message 122/222. In a non-emergency context, the text content of the RTT message 122 may be received by, and displayed on, a terminating UE 102. In an emergency context, a PSAP 202 terminal may receive and display the text content of the RTT message 222. The text content of the RTT message 122/222 may be machine-generated or user-generated (e.g., created or selected by the user), as described herein.

For example, at 708, the originating UE 100/200 may select, without user interaction, the text content from stored text content available to the originating UE 100/200 prior to sending the text content at 706. In some embodiments, the automatic selection of the text content at 708 may occur in response to determining that the user input received at 702 includes an emergency short code. In other words, user input corresponding to an emergency short code (e.g., 911 in the United States) may trigger the machine-generation of text content (e.g., “This is a RTT call”) that is to be sent to the PSAP 202 in an early RTT message 222. In other examples, there may be other triggers for the originating UE 100/200 selecting text content automatically and without user interaction. In some cases, the originating UE 100/200 may be configured to send an automatic RTT message by default, unless settings are changed by the user.

As another example, at 710, the originating UE 100/200 may displaying, on a display of the originating UE 100/200, (i) a text input mechanism 506 for entering user-generated text content, such as a free form text entry field, and (ii) selectable text content 504 for selection by a user of the originating UE 100/200. Following the display of the input mechanism 506 and the selectable text content 504 at 710, the originating UE 100/200 may, at 712, receive additional user input that causes at least one of the user-generated text content or the selectable text content to be entered into the text input mechanism 506. Thus, optional sub-blocks 710 and 712 allow for the text content to include text content created or selected by the user of the originating UE 100/200, while optional sub-block 708 allows of the text content to include machine-selected text content that does not involve user interaction.

At 714, the originating UE 100/200 may establish the primary communication session after the sending of the text content in the RTT message 122/222. The primary communication session (e.g., a RTT call) may be established over the telecommunications network 104/204.

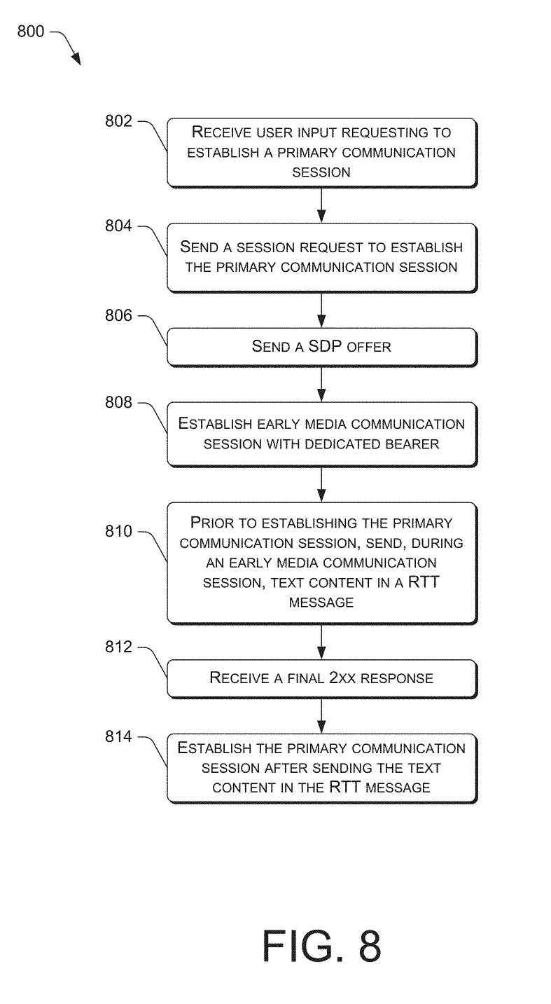

FIG. 8 illustrates a flowchart of a more detailed example process 800 for early transmission of a RTT message 122/222 during setup of a primary communication session. The process 800 may be implemented by an originating UE, such as the originating UE 100 or 200 of FIGS. 1 and 2A. The process 800 is described, by way of example, with reference to the previous figures.

At 802, an originating UE 100/200 may receive user input requesting to establish a primary communication session. The operation(s) at block 802 may be similar to the operation(s) described with respect to block 702 of the process 700 of FIG. 7.

At 804, the originating UE 100/200 may send, over a telecommunications network 104/204, a session request 108/208 to establish the primary communication session. The operation(s) at block 804 may be similar to the operation(s) described with respect to block 704 of the process 700 of FIG. 7.

At 806, the originating UE 100/200 may send, over the telecommunications network 104/204, a SDP offer 114/214 to negotiate initialization parameters for text content of an early RTT media session. As mentioned herein, the SDP offer 114/214 sent at block 806 may be the same SDP offer used to negotiate initialization parameters for voice content of the primary communication session, or, alternatively, the early media communication session and the primary communication session may be setup using separate SDP offers.

At 808, an early media communication session may be established with a dedicated bearer for a RTT media stream of the early media communication session. The dedicated bearer may be assigned by one or more nodes of the telecommunications network 104/204, and may be a same dedicated bearer as the dedicated bearer assigned to a media stream for the primary communication session (e.g., a dedicated bearer for voice data), but the early media and primary sessions do not have to use the same dedicated bearer.

At 810, prior to establishing the primary communication session, and during an early media communication session, the originating UE 100/200 may send text content in a RTT message 122/222. The operation(s) at block 810 may be similar to the operation(s) described with respect to block 706 of the process 700 of FIG. 7, and may include operations similar to the operations described with respect to one or more of the optional sub-blocks of block 706 (e.g., blocks 708, 710, and/or 712).

At 812, the originating UE 100/200 may receive a 2xx response 130/230 indicating a successful connection with a terminating device. In a non-emergency context, the terminating device may be a terminating UE 102. In an emergency context, the terminating device may be a PSAP 202.

At 814, the originating UE 100/200 may establish the primary communication session after the sending of the text content in the RTT message 122/222. The operation(s) at block 814 may be similar to the operation(s) described with respect to block 714 of the process 700 of FIG. 7.

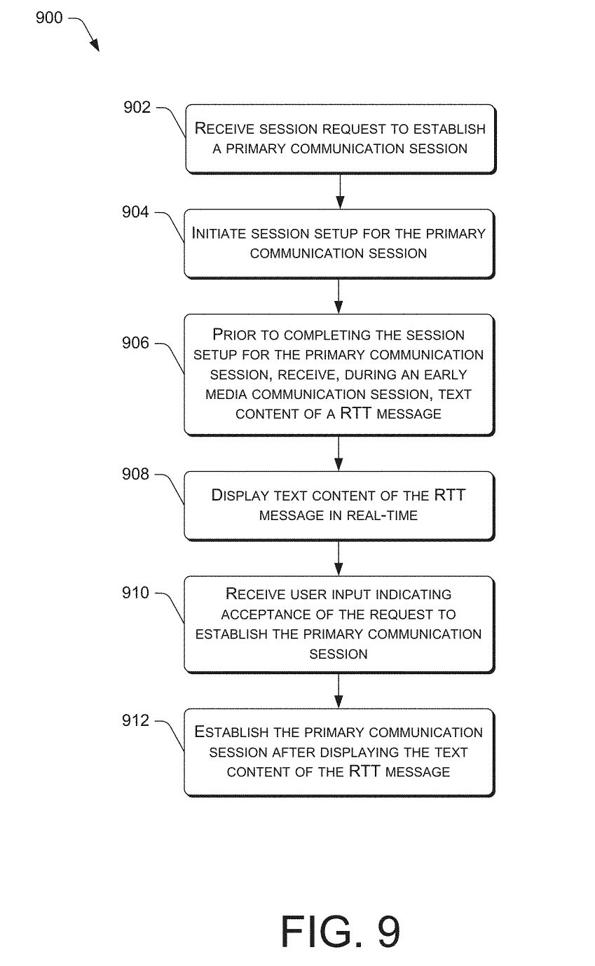

FIG. 9 illustrates a flowchart of an example process 900 for early reception of a RTT message during setup of a primary communication session. The process 900 may be implemented by a receiving terminal (e.g., a terminating UE 102, a PSAP 202 terminal, or a UE 300, when acting as a terminating UE 300). The process 900 is described, by way of example, with reference to the previous figures.

At 902, a terminal may receive, over a telecommunications network 104/204/304, a session request 108/208/308(2) to establish a primary communication session. The session request may be in the form of a SIP INVITE.

At 904, the terminal may initiate a session setup for the primary communication session. This may involve performing one or more setup procedures of various setup procedures described herein.

At 906, prior to completing the session setup for establishing the primary communication session, the terminal may receive, during an early media communication session, text content of a RTT message 122/222/322.

At 908, the terminal may display, on a display of the terminal during the early media communication session, the text content of the RTT message 122/222/322. An example of this is shown in the user interface 600 of FIG. 6 for a non-emergency context. That is, the text content of a received RTT message 122 is displayed in a RTT display area 606 of the user interface 600. The RTT display area 606 may be proximate (e.g., adjacent) to soft buttons to “accept” 602 or “decline” 604 the request to establish the primary communication session. It is to be appreciated that, in an emergency context, text content, such as “This is a RTT call,” may be displayed on a PSAP 202 terminal, or text content, such as “This is a PSAP callback,” may be displayed on a UE 300 that receives a callback from a PSAP 302.

At 910, the terminal may receive user input indicating that a user of the terminal accepts the request to establish the primary communication session. For example, this may involve the user selecting an “accept” soft button 602 on a touch screen of the terminal.

At 912, the primary communication session may be established after the displaying of the text content of the RTT message 122/222/322, and in response to the receiving of the user input at block 910.

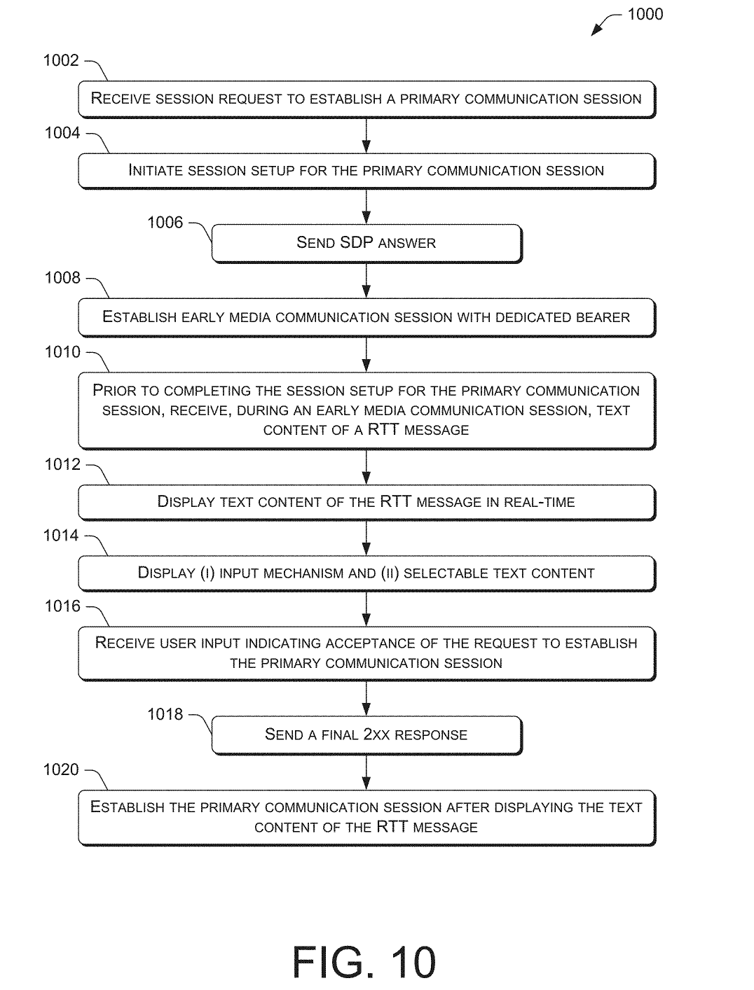

FIG. 10 illustrates a flowchart of an example process 1000 of a more detailed example process 1000 for early reception of a RTT message 122/222/322 during setup of a primary communication session. The process 1000 may be implemented by a receiving terminal (e.g., a terminating UE 102, a PSAP 202 terminal, or a UE 300, when acting as a terminating UE 300). The process 1000 is described, by way of example, with reference to the previous figures.

At 1002, a terminal may receive, over a telecommunications network 104/204/304, a session request 108/208/308(2) to establish a primary communication session. The operation(s) at block 1002 may be similar to the operation(s) described with respect to block 902 of the process 900 of FIG. 9.

At 1004, the terminal may initiate a session setup for the primary communication session. This may involve performing one or more setup procedures of various setup procedures described herein.

At 1006, the terminal may send a SDP answer 116/216/316 to negotiate initialization parameters for text content of an early RTT media session. As mentioned herein, the SDP answer 116/216/316 sent at block 1006 may be the same SDP answer used to negotiate initialization parameters for voice content of the primary communication session, or, alternatively, the early media communication session and the primary communication session may be setup using separate SDP answers.

At 1008, an early media communication session may be established with a dedicated bearer for a RTT media stream of the early media communication session. The dedicated bearer may be assigned by one or more nodes of the telecommunications network 104/204/304, and may be a same dedicated bearer as the dedicated bearer assigned to a media stream for the primary communication session (e.g., a dedicated bearer for voice data), but the early media and primary sessions do not have to use the same dedicated bearer.

At 1010, prior to completing the session setup for establishing the primary communication session, the terminal may receive, during an early media communication session, text content of a RTT message 122/222/322. The operation(s) at block 1010 may be similar to the operation(s) described with respect to block 906 of the process 900 of FIG. 9.

At 1012, the terminal may display, on a display of the terminal during the early media communication session, the text content of the RTT message 122/222/322. The operation(s) at block 1012 may be similar to the operation(s) described with respect to block 908 of the process 900 of FIG. 9.

At 1014, the terminal may display, on a display of the terminal, (i) a text input mechanism (e.g., a text entry field similar to the input mechanism 506 of FIG. 5) for entering user-generated text content, such as a free form text entry field, and (ii) selectable text content (e.g., similar to the selectable text content 504 of FIG. 5) for selection by a user of the terminal. This allows a called party associated with the terminal to reply with a RTT message during the setup of the primary communication session.

At 1016, the terminal may receive user input indicating that a user of the terminal accepts the request to establish the primary communication session. The operation(s) at block 1016 may be similar to the operation(s) described with respect to block 910 of the process 900 of FIG. 9.

At 1018, the terminal may send a 2xx response 130/230/330 indicating a successful connection with an originating terminal.

At 1020, the primary communication session may be established after the displaying of the text content of the RTT message 122/222/322 at block 1012, and in response to the receiving of the user input at block 1016 and the sending of the final 2xx response at block 1018. The operation(s) at block 1020 may be similar to the operation(s) described with respect to block 912 of the process 900 of FIG. 9.

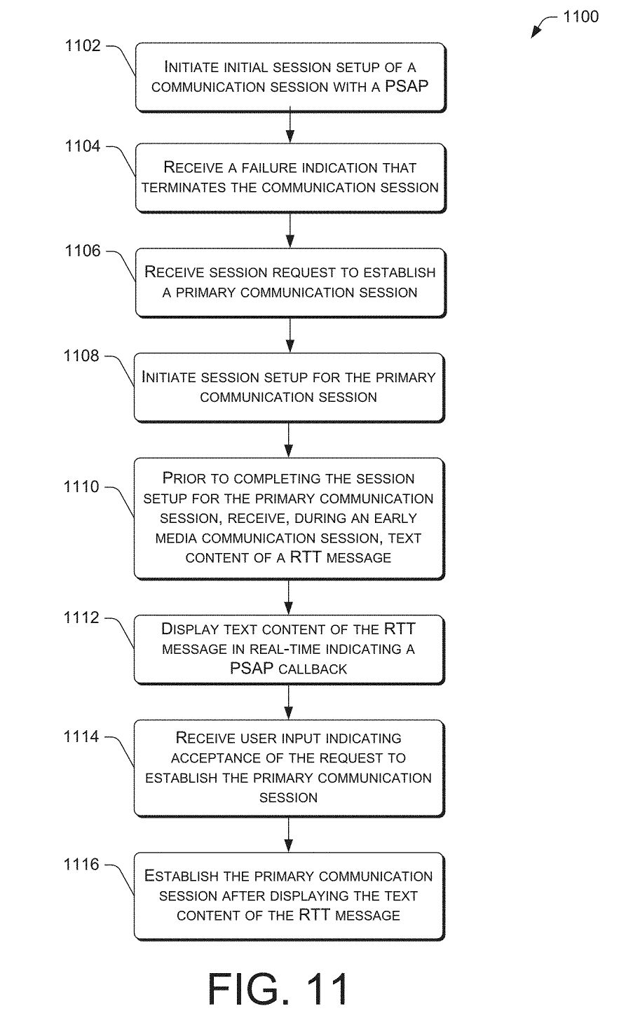

FIG. 11 illustrates a flowchart of an example process 1100 for early reception of a RTT message 322 in a callback from a PSAP 302. The process 1100 may be implemented by a UE 300 acting as a terminating UE 300, and after experiencing a failure of an initial communication session. The process 1100 is described, by way of example, with reference to the previous figures.

At 1102, a terminal (e.g., the UE 300 of FIG. 3), acting as an originating UE 300, may initiate an initial session setup for a communication session with PSAP 302. This may involve transmitting a first session request 308(1), among other session setup procedures.

At 1104, the terminal 300 may receive at least one of (i) an indication of a failure to establish the communication session with the PSAP 302, or (ii) an indication that the communication session with the PSAP 302 has been dropped after establishment.

At 1106, the terminal 300 may receive, over a telecommunications network 304, a session request 308(2) to establish a primary communication session. This session request may be a callback from the PSAP 302 in response to the failed initial communication session. The operation(s) at block 1106 may be similar to the operation(s) described with respect to block 902 of the process 900 of FIG. 9.

At 1108, the terminal may initiate a session setup for the primary communication session. This may involve performing one or more setup procedures of various setup procedures described herein.

At 1110, prior to completing the session setup for establishing the primary communication session, the terminal 300 may receive, during an early media communication session, text content of a RTT message 322. The operation(s) at block 1110 may be similar to the operation(s) described with respect to block 906 of the process 900 of FIG. 9.

At 1112, the terminal 300 may display, on a display of the terminal 300 during the early media communication session, the text content of the RTT message 322. For example, text content, such as “This is a PSAP callback” or “This is the 911 operator,” may be displayed on a terminal 300 that receives a callback from a PSAP 302. The operation(s) at block 1112 may be similar to the operation(s) described with respect to block 908 of the process 900 of FIG. 9

At 1114, the terminal 300 may receive user input indicating that a user of the terminal 300 accepts the request to establish the primary communication session. The operation(s) at block 1114 may be similar to the operation(s) described with respect to block 910 of the process 900 of FIG. 9.

At 1116, the primary communication session may be established after the displaying of the text content of the RTT message 322, and in response to the receiving of the user input at block 1114. The operation(s) at block 1116 may be similar to the operation(s) described with respect to block 912 of the process 900 of FIG. 9

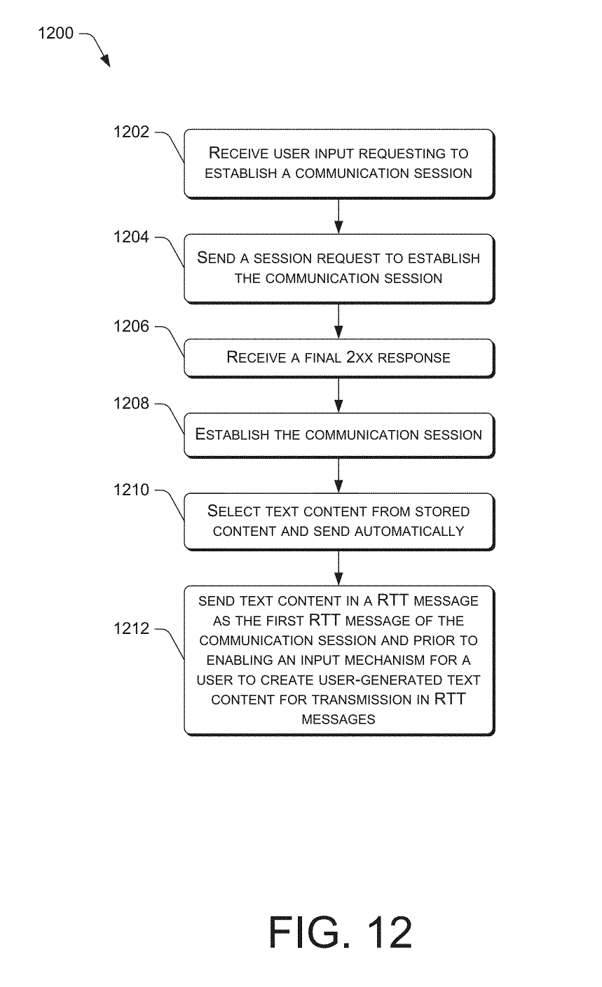

FIG. 12 illustrates a flowchart of an example process 1200 for automatically sending, without user interaction, text content by an originating UE 200 in a first RTT message 222 of many possible RTT messages that can be sent during the communication session. FIG. 12 may be implemented by an originating UE, such as the originating UE 200 of FIG. 2B. The process 1200 is described, by way of example, with reference to the previous figures.

At 1202, an originating UE 200 may receive user input requesting to establish a primary communication session. The operation(s) at block 1202 may be similar to the operation(s) described with respect to block 702 of the process 700 of FIG. 7.

At 1204, the originating UE 200 may send, over a telecommunications network 204, a session request 208 to establish the primary communication session. The operation(s) at block 1204 may be similar to the operation(s) described with respect to block 704 of the process 700 of FIG. 7.

At 1206, the originating UE 100/200 may receive a 2xx response 130/230 indicating a successful connection with a terminating device. The operation(s) at block 1206 may be similar to the operation(s) described with respect to block 812 of the process 800 of FIG. 8.

At 1208, the originating UE 200 may establish the primary communication session. The operation(s) at block 1208 may be similar to the operation(s) described with respect to block 714 of the process 700 of FIG. 7.

At 1210, the originating UE 200 may select, without user interaction, text content from stored text content available to the originating UE 200 for use in a RTT message 222. The operation(s) at block 1210 may be similar to the operation(s) described with respect to block 708 of the process 700 of FIG. 7.

At 1212, the originating UE 200 may send the text content in a RTT message 222 before enabling an input mechanism (e.g., the text input mechanism 506 of FIG. 5) for a user of the originating UE 200 to create user-generated text content for transmission in RTT messages during the communication session. The RTT message 222 may be a first RTT message 222 of many possible RTT messages sent during the communication session. As described herein, this may be beneficial in emergency contexts where the user dials 911, but the PSAP 202 does not support early media, such as early RTT media. Therefore, the machine-generated RTT message 222 can be sent as the first RTT message to inform personnel of the PSAP 202 that the incoming request is a RTT call.

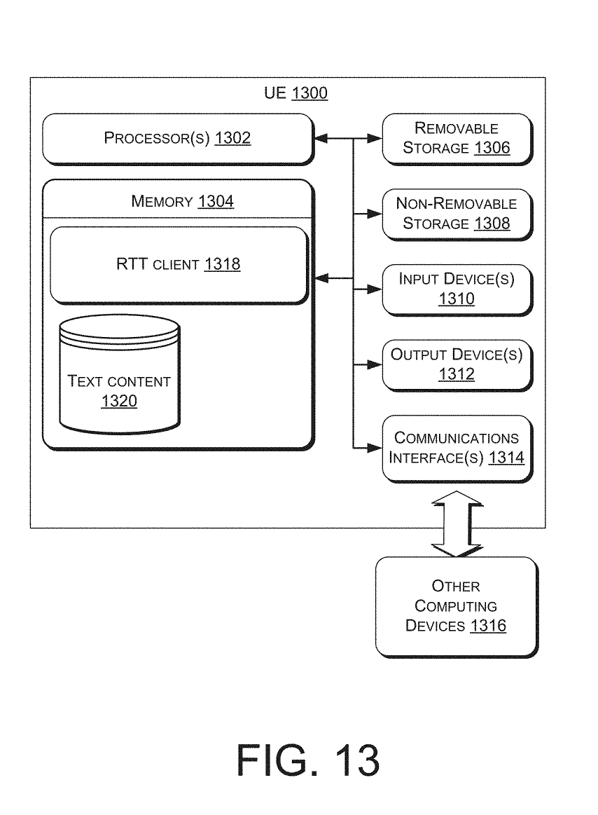

FIG. 13 is a block diagram of an example UE 1300 configured to transmit and receive RTT messages 122/222/322 prior to, and during, a primary communication session. The UE 1300 may be representative of the UE's 100/102/200/300 described herein.

As shown, the UE 1300 may include one or more processors 1302 and one or more forms of computer-readable memory 1304. The UE 1300 may also include additional storage devices. Such additional storage may include removable storage 1306 and/or non-removable storage 1308.

The UE 1300 may further include input devices 1310 and output devices 1312 communicatively coupled to the processor(s) 1302 and the computer-readable memory 1304. The UE 1300 may further include communications interface(s) 1314 that allow the UE 1300 to communicate with other computing devices 1316 (e.g., IMS nodes, other UEs) such as via a network. The communications interface(s) 1314 may facilitate transmitting and receiving wired and/or wireless signals over any suitable communications/data technology, standard, or protocol, as described herein. For example, the communications interface(s) 1314 can comprise one or more of a cellular radio, a wireless (e.g., IEEE 802.1x-based) interface, a Bluetooth® interface, and so on. In some embodiments, the communications interface(s) 1314 may include radio frequency (RF) circuitry that allows the UE 1300 to transition between different RATs, such as transitioning between communication with a 4G or 5G LTE RAT and a legacy RAT (e.g., 3G/2G). The communications interface(s) 1314 may further enable the UE 1300 to communicate over circuit-switch domains and/or packet-switch domains.

In various embodiments, the computer-readable memory 1304 comprises non-transitory computer-readable memory 1304 that generally includes both volatile memory and non-volatile memory (e.g., random access memory (RAM), read-only memory (ROM), erasable programmable read-only memory (EEPROM), Flash Memory, miniature hard drive, memory card, optical storage, magnetic cassettes, magnetic tape, magnetic disk storage or other magnetic storage devices, or any other medium). The computer-readable memory 1304 may also be described as computer storage media and may include volatile and nonvolatile, removable and non-removable media implemented in any method or technology for storage of information, such as computer readable instructions, data structures, program modules, or other data. Computer-readable memory 1304, removable storage 1306 and non-removable storage 1308 are all examples of non-transitory computer-readable storage media. Computer-readable storage media include, but are not limited to, RAM, ROM, EEPROM, flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by the UE 1300. Any such computer-readable storage media may be part of the UE 1300.

The memory 1304 can include a RTT client 1318 (i.e., computer-executable instructions (or logic)) that, when executed, by the processor(s) 1302, perform the various acts and/or processes disclosed herein. The UE 1300 may store text content 1320 in the memory 1304 of the UE 1300 for access in performing the various acts and/or processes disclosed herein.

The environment and individual elements described herein may of course include many other logical, programmatic, and physical components, of which those shown in the accompanying figures are merely examples that are related to the discussion herein.

The various techniques described herein are assumed in the given examples to be implemented in the general context of computer-executable instructions or software, such as program modules, that are stored in computer-readable storage and executed by the processor(s) of one or more computers or other devices such as those illustrated in the figures. Generally, program modules include routines, programs, objects, components, data structures, etc., and define operating logic for performing particular tasks or implement particular abstract data types.

Other architectures may be used to implement the described functionality, and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

1. An originating user equipment (UE) comprising:
a processor; and
memory storing computer-executable instructions that, when executed by the processor, cause the originating UE to:
receive user input requesting to establish a primary communication session;
send, over a telecommunications network, a session request to establish the primary communication session;
establish the early media communication session with a dedicated bearer assigned by the telecommunications network;
prior to establishing the primary communication session, send, during the early media communication session, text content in a real time text (RTT) message; and
establish the primary communication session after sending the text content in the RTT message,
wherein the dedicated bearer assigned to a RTT media stream for the early media communication session is a same dedicated bearer that is assigned to a voice media stream for the primary communication session.

2. The originating UE of claim 1, wherein:
the memory further stores available text content for the originating UE to insert into RTT messages; and
the text content is selected, by the originating UE, prior to sending the text content in the RTT message, and without user interaction, from the available text content stored in the memory.

3. The originating UE of claim 2, wherein:
the user input includes an emergency short code that requests the primary communication session be established with a public safety answering point (PSAP); and
the text content is selected from the available text content in response to determining that the user input includes the emergency short code.

4. The originating UE of claim 1, further comprising a display, wherein the computer-executable instructions, when executed by the processor, further cause the originating UE to, after receiving the user input, display, on the display:
information indicating that a called party is being contacted;
a text entry field for entering user-generated text content for transmission in the RTT message; and
selectable text content that, upon selection by a user of the originating UE, is inserted into the RTT message.

5. The originating UE of claim 4, wherein the text content sent in the RTT message includes at least one of the user-generated text content or the selectable text content selected by the user.

6. The originating UE of claim 1, wherein:
the session request includes a header containing information indicating that the originating UE supports RTT early media
the computer-executable instructions, when executed by the processor, further cause the originating UE to, after sending the session request and prior to sending the text content in the RTT message:
send, over the telecommunications network, a Session Description Protocol (SDP) offer to negotiate initialization parameters for the text content.

7. A method comprising:
receiving, by an originating user equipment (UE), user input requesting to establish a primary communication session;
sending, by the originating UE over a telecommunications network, a session request to establish the primary communication session;
establishing an early media communication session with a dedicated bearer assigned by the telecommunications network;
prior to establishing the primary communication session, sending, by the originating UE during the early media communication session, text content in a real time text (RTT) message; and
establishing the primary communication session after the sending of the text content in the RTT message,
wherein the dedicated bearer assigned to a RTT media stream for the early media communication session is a same dedicated bearer that is assigned to a voice media stream for the primary communication session.

8. The method of claim 7, further comprising selecting, by the originating UE and without user interaction, the text content from stored text content available to the originating UE.

9. The method of claim 8, wherein:
the user input includes an emergency short code that requests the primary communication session be established with a public safety answering point (PSAP); and
the text content is selected from the stored text content in response to determining that the user input includes the emergency short code.

10. The method of claim 7, further comprising, in response to the receiving of the user input, displaying, on a display of the originating UE:
information indicating that a called party is being contacted;
a text entry field for entering user-generated text content; and
selectable text content for selection by a user of the originating UE.

11. The method of claim 10, further comprising receiving, by the originating UE, additional user input, the additional user input causing at least one of the user-generated text content or the selectable text content to be entered into the text entry field,
wherein the text content sent in the RTT message includes at least one of the user-generated text content or the selectable text content selected by the user.

12. The method of claim 10, wherein the selectable text content indicates at least one of an urgency of the communication session or an identity of the user of the originating UE.

13. The method of claim 7, wherein:
the session request comprises a Session Initiation Protocol (SIP) INVITE method;
the establishing of the primary communication session occurs in response to receiving, by the originating UE, a 2xx response indicating a successful connection with a terminating device; and
the sending of the text content in the RTT message occurs prior to the receiving of the 2xx response.

14. The method of claim 7, wherein the session request includes a header containing information indicating that the originating UE supports RTT early media, the method further comprising, after the sending of the session request and prior to the sending of the text content in the RTT message:
sending a Session Description Protocol (SDP) offer to negotiate initialization parameters for the text content.

15. (canceled)

16. A method comprising:
receiving, by a terminal over a telecommunications network, a session request to establish a primary communication session;
initiating, by the terminal, a session setup for the primary communication session;
establishing an early media communication session with a dedicated bearer assigned by the telecommunications network;
prior to completing the session setup for establishing the primary communication session, receiving, by the terminal during the early media communication session, text content of a real time text (RTT) message;
displaying, on a display of the terminal during the early media communication session, the text content of the RTT message;
receiving, by the terminal, user input indicating that a user of the terminal accepts the request to establish the primary communication session; and
establishing the primary communication session after the displaying of the text content of the RTT message and in response to the receiving of the user input,
wherein the dedicated bearer assigned to a RTT media stream for the early media communication session is a same dedicated bearer that is assigned to a voice media stream for the primary communication session.

17. The method of claim 16, further comprising, prior to the receiving of the session request:
initiating, by the terminal acting as an originating user equipment (UE), an initial session setup for a communication session with a public safety answering point (PSAP); and
receiving, by the terminal, at least one of (i) an indication of a failure to establish the communication session with the PSAP, or (ii) an indication that the communication session with the PSAP has been dropped after establishment,
wherein the session request received by the terminal is a callback from the PSAP, and
wherein the text content of the RTT message indicates that the session request is the callback from the PSAP.

18. (canceled)

19. (canceled)

20. The method of claim 19, further comprising displaying, on the display of the terminal during the early media communication session, along with the text content of the RTT message:
information indicating that a calling party is requesting the primary communication session;
a text entry field for entering user-generated text content; and
selectable text content for selection by the user of the terminal.
